(19) United States
(12) Patent Application Publication
(10) Pub. No.: US 2020/0056980 A1
(43) Pub. Date: Feb. 20, 2020

(54) Portable Air Quality Sensing Device and Air Quality Sensing Method Therefor

(71) Applicants: Robert Bosch GmbH, Stuttgart (DE); TRUMPF Photonic Components GmbH, Ulm (DE)

(72) Inventors: Stefan Weiss, Tübingen (DE); Alexander Herrmann, Reutlingen (DE)

(21) Appl. No.: 16/541,780

(22) Filed: Aug. 15, 2019

(30) Foreign Application Priority Data
Aug. 17, 2018 (DE) 102018213923.7

(51) Int. Cl. G01N 15/14; G01N 15/02

(52) U.S. Cl. CPC G01N 15/1431; G01N 2001/2276; G01N 2201/0221; G01N 15/0205

(57) ABSTRACT

The present invention provides a portable air quality sensing device and a corresponding air quality sensing method. The portable air quality sensing device is equipped with environmental parameter detecting means (10) configured to detect local readings of one or more environmental parameters affecting air quality; retrieval means (150) for retrieving at least one global AQI value and/or at least one global measurement of an environmental parameter affecting air quality contributing to the global AQI value from at least one remote reading data source means (200) via a network (500); and an evaluation device (20) configured to form a local AQI value based on said one or more detected local readings and said at least one global AQI value and/or on said at least one retrieved global reading.

The present invention pertains to a portable air quality sensing device and a corresponding air quality sensing method.

Although applicable to any air quality sensing device, this invention and its underlying problem are described with respect to air quality sensing devices integrated in mobile devices.

### STATE OF THE ART

Air pollution by suspended particles, especially PM2.5 fine dust or P10 fine dust, and by toxic gases is one of the world's most serious health threats and the cause of many premature deaths. Poor air quality is particularly dangerous for children, the elderly and people with medical impairments.

The air quality is determined by numerous limit or guideline values laid down in laws or regulations. Air quality monitoring is usually carried out at monitoring stations located, for example, on busy roads or in landscape areas.

Many countries have defined scalar air quality indices, which are also referred to as AQI values. Other designations are Air Quality Health Index, Air Pollution Index or Pollution Standard Index, etc.

The purpose of these AQI values is to inform the public about current air pollution conditions with a simple scalar numerical value, i.e. without indicating the concentration and limit values of the specific pollutants. Based on these simple scalar AQI values, recommendations can be made for specific groups of persons or for all persons.

The definition of the respective AQI value differs from country to country with respect to the specific impurities contributing to the AQI value and with respect to the specific algorithm used to form the AQI value based on the concentrations of the contributing specific impurities and with respect to the rating scale used to interpret the respective AQI value.

Typical impurities which are used to generate the AQI value are the PM2.5 fine dust concentration, the PM10 fine dust concentration, concentrations of predetermined gases, for example SOₓ, NOₓ, especially SO₂ and NO₂, O₃, CO, NH₃, CO₂ or CH₂O and the like. In some countries, a Pb concentration and a NH₃ concentration are also used.

The respective current AQI value is typically provided by the authorities at official measuring stations. These current AQI values can be accessed via the Internet and apps on mobile devices such as smartphones.

Disadvantageously, the AQI values issued by the authorities refer to the immediate vicinity of the measuring stations. In practice, the AQI values provided are partly averaged over time (e.g. over hours and in particular over 24 hours) and/or averaged over various measuring stations in a larger area. This value, which is also called the “global AQI value”, should therefore be valid for a larger spatial area (e.g. district or city). Thus, deviations between the published official global AQI value and the actual local AQI value can be very considerable. Furthermore, official AQI values are only published for outdoor areas and not for indoor areas.

However, many people frequently change their location during the day and expose themselves to variable AQI values during the course of the day, which are typically different from publicly available exposure values.

In recent years, particle sensors and gas sensors with a volume of less than 1 cm³ have been developed. This opens up new possibilities for the integration of such particle sensors and/or gas sensors in mobile devices such as smartphones or the like. As a result, it is now basically possible to determine certain actual particle/gas exposure values of a person who constantly carries a corresponding sensor with him.

DE 10 2015 207 289 A1 discloses an optical particle sensor device with a VCSEL laser diode with integrated photodiode. A VCSEL laser diode (VCSEL=vertical-cavity surface-emitting laser) is a light-emitting diode in which the light is emitted perpendicular to the plane of the semiconductor chip. By means of the self-mixing interference technique, the well-known particle sensor device makes it possible to obtain information regarding the presence of particles, in particular particle number and particle velocity.

FIG. 3 shows a block diagram explaining an optical particle sensor device known from DE 10 2015 207 289 A1.

In FIG. 3, reference sign 50a denotes an optical emitter device and 50b an optical detector device, wherein the optical emitter device 50a is a VCSEL laser and the optical detector device 50b is a photodiode. The 50a optical emitter device and the 50b optical detector device are integrated into a VCSEL sensor chip 66 in which a self-mixing interference analysis function is integrated. The optical emitter device 50a emits an optical measuring beam 52. By means of a lens device 58, the optical measuring beam 52 is focused in a focus range 60 in which the particles 56 are to be detected.

The measuring beam 62 scattered by the particles is focused onto a detection surface 64 of the VCSEL sensor chip 66 by the lens device 58. An optional mirror device 74 allows the focus area 60 to be shifted one- or two-dimensionally within the focus area 60.

The optical detector device 50b is configured to output an information signal 68 regarding an intensity and/or an intensity distribution of the scattered electrical measuring beam 62 occurring on the detection surface 64. An evaluation device 70 supplies an information signal 72 regarding the presence of particles 56, a particle number and/or another property of the particles 56. In particular, the particle velocity is also of interest.

The self-mixing interference method is described, for example, in G. Giuliani et al., Laser Diode Self-Mixing Technique for Sensing Applications, Journal of Optics A: Pure and Applied Optics, 2002, 4, p. 283-S 294. It is based on the fact that a measuring beam backscattered by a particle interferes with the emitted measuring beam and thereby modulates the emitted intensity of the measuring beam.

US 2016/0025628 A1 discloses a smartphone with an integrated optical particle sensor device.

DE 10 2009 045 977 A1 discloses a mobile device that is configured as an automated component for integration into a security system to secure people and/or areas.

### DISCLOSURE OF THE INVENTION

The present invention provides a portable air quality sensing device according to independent claim 1 and a corresponding air quality sensing method according to independent claim 15.

Preferential embodiments are the subject of the respective subclaims.

### Advantages of the Invention

The present invention is based on the idea of providing a portable air quality sensing device capable of forming a local AQI value based on one or more sensed local measurements and at least one remotely sensed global AQI value and/or at least one remotely sensed global measurement.

The advantage of the inventive portable air quality sensing device and the corresponding air quality sensing method is that it allows the forming of a local AQI value based on locally available readings for a specific group of people and on globally available readings, which is much more accurate or reliable than available purely global AQI values.

According to a preferred embodiment, the environmental parameter detecting means comprises an optical particle concentration detection device which is configured to acquire local readings of an instantaneous site-specific particle concentration of predetermined particles as the environmental parameter. The particle concentration of predetermined particles is particularly relevant for air quality sensing and potential health risks.

According to another preferred embodiment, the particle concentration is a PM2.5 fine dust concentration and/or a PM10 fine dust concentration. Particulate matter is one of the greatest health risks.

According to another preferred embodiment, the environmental parameter detecting means comprises at least one gas sensor device which is configured to detect local readings of an instantaneous site-specific gas concentration of a predetermined gas as the environmental parameter. Gas concentrations of predetermined gases are also relevant for air quality sensing and potential health risks.

According to another preferred embodiment, the predetermined gas is SOₓ, NOₓ, O₃, CO, NH₃, CO₂ or CH₂O. Such gases are particularly harmful to health if their concentrations exceed certain limits.

According to another preferred embodiment, the environmental parameter detecting means is configured to acquire local readings of a local temperature or humidity as the environmental parameter. Temperature and humidity are relevant environmental parameters for determining air quality.

According to another preferred embodiment, the evaluation device is configured to correct at least one detected local reading of the at least one air quality influencing environmental parameter by means of at least one retrieved global reading for forming the local AQI value. In this way further correction factors can be determined which are not locally available.

In accordance with another preferred embodiment, the evaluation device is configured to correct a detected local reading of the instantaneous site-specific particle concentration of predetermined particles by means of at least one retrieved global reading.

According to another preferred embodiment, the at least one retrieved global reading is a humidity or a temperature or a gas concentration.

According to another preferred embodiment, the particle concentration detection device has an optical emitter device for directing at least one optical measuring beam through an optical exit region outside a housing into a focus region within which particle detection can be carried out, and optical detector device disposed within the housing for detecting the measuring beam scattered by particles and for outputting information about the particle concentration. Such a particle concentration detection device can be designed to be particularly compact.

According to another preferred embodiment, the optical emitter device has a laser diode, in particular a VCSEL diode, and the optical detector device has a photodiode integrated in the laser diode.

According to another preferred embodiment, the measuring beam and the scattered measuring beam can be analyzed by the algorithm using the self-mixing interference method.

According to another preferred embodiment, the portable air quality sensing device is disposed within a portable device, especially within a smartphone. This considerably simplifies operation for the user and allows a combination with other functionalities.

In another preferred embodiment, the portable air quality sensing device comprises a transmission device for transmitting the formed local AQI value to at least one measurement data source device over the network. This allows other people in the area who do not carry an air quality sensing device, for example, to benefit from the readings.

### BRIEF DESCRIPTION OF THE DRAWINGS

It is shown in:

FIG. 1 a block diagram explaining a portable air quality sensing device according to a first embodiment of the present invention;

FIG. 2 a block diagram explaining a portable air quality sensing device according to a second embodiment of the present invention; and

FIG. 3 a block diagram explaining an optical particle sensor device known from DE 10 2015 207 289 A1.

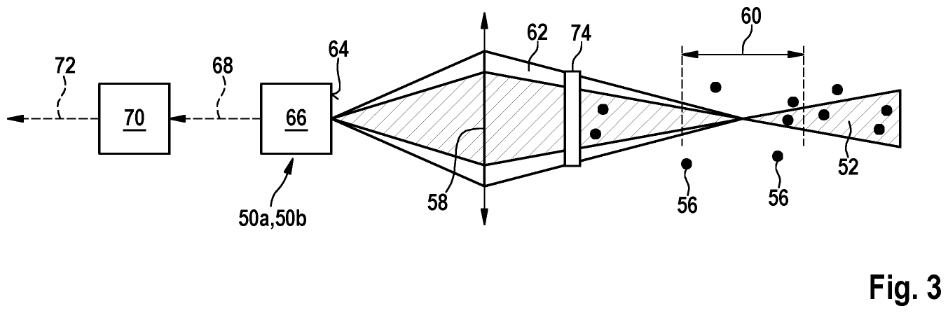

In the figures, identical or functionally identical elements are provided with the same reference signs.

### DESCRIPTION OF THE EMBODIMENTS

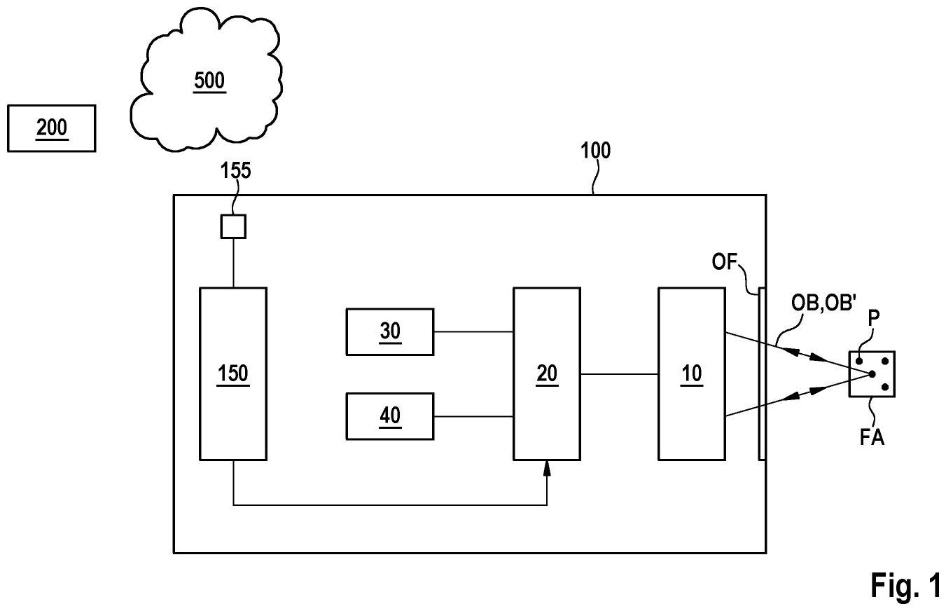

FIG. 1 is a block diagram illustrating a portable air quality sensing device according to a first embodiment of the present invention.

In FIG. 1, reference sign 100 denotes a housing, for example the housing of a smartphone, in which an environmental parameter detecting means in the form of an optical particle concentration detection device 10 is provided, which is configured to detect readings of an instantaneous particle concentration of predetermined particles in a time-controlled measuring operation and/or in an event-controlled measuring operation. In the present embodiment, the particles are PM2.5 fine dust particles.

The particle concentration detection device 10 has an optical emitter device LD for directing an optical measuring beam OB through an optical exit area OF outside the housing 100 into a focus area FA. Particle P can be detected within the focus range FA. Also disposed within the housing 100 is an optical detector device DD′ for detecting the measuring beam OB′ scattered by the particles P and for outputting information about the particle concentration.

In the present embodiment, the LD optical emitter device is a laser diode, in particular a VCSEL diode, and the DD optical detector device is a photodiode integrated in the laser diode. To determine the particle concentration, the measuring beam OB and the scattered measuring beam OW are analysed by an algorithm using the self-mixing interference method, as explained above.

The readings of an instantaneous particle concentration of the PM2.5 fine dust particles determined by the particle concentration detection means 10 are transferred to an evaluation device 20. The respective readings of the PM2.5 fine dust particle concentration are referred to here as P₁^{local}.

A retrieval means 150 connected to a GSM antenna 155 is configured to retrieve a global AQI value and a plurality of global measurements of air quality influencing environmental parameters contributing to the global AQI value from a remote measurement data source 200 of a (non-displayed) public measuring station over a network 500 such as the Internet.

The retrieved global AQI value AQI^{global} and the majority of global readings P₁^{global}, P₂^{global}, P₃^{global}, . . . , Pₙ^{global} of air quality influencing environmental parameters that contribute to the global AQI value AQI^{global} can be functionally (fct) represented as:

AQI^{global}=fct(P₁^{global},P₂^{global},P₃^{global}, . . . ,Pₙ^{global})

where n is a natural number denoting the total number of global readings retrieved. In this example, n=4 is assumed, wherein
P₁^{global}=global reading of PM2.5 fine dust particle concentration
P₂^{global}=global reading of CO gas concentration
P₃^{global}=global reading of NOₓ gas concentration (e.g. x=2)
P₄^{global}=global reading of SOₓ gas concentration (e.g. x=2).

The evaluation device 20 is configured to form a local AQI value AQI^{local} based on the respective recorded local reading of the PM2.5 fine dust particle concentration P₁^{local} and the retrieved global readings P₂^{global}, P₃^{global}, P₄^{global}.

The local AQI value AQIlocal formed in this way can be represented functionally (fct) as:

AQI^{local}=fct(P₁^{local},P₂^{global},P₃^{global},P₄^{global})

The functional relationship (fct) used when forming can be stored user-specifically or country-specifically in the air quality sensing device or can also be retrieved from the data source device 200 or another (unrepresented) data source device.

A display device 30 connected to the evaluation device 20 enables a visual representation of the local AQI value AQI^{local} for the user. Further display modes are possible, e.g. an additional display of the PM2.5 fine dust particle concentration P₁^{personal} and/or the retrieved global AQI value AQI^{global} and/or the majority of global readings P₂^{global}, P₃^{global}, P₄^{global}.

The display device 30 can optionally be configured to issue warnings if the local AQI value AQI^{local} is within a highly hazardous range.

By means of a transmission device 40, the formed local AQI value AQI^{local} can be transmitted to the reading data source device 200 or another (not displayed) data source device via the network 500.

Thus, the embodiment described above enables the forming of a constantly updatable local AQI value AQI^{local}, which is available to both the user and other persons.

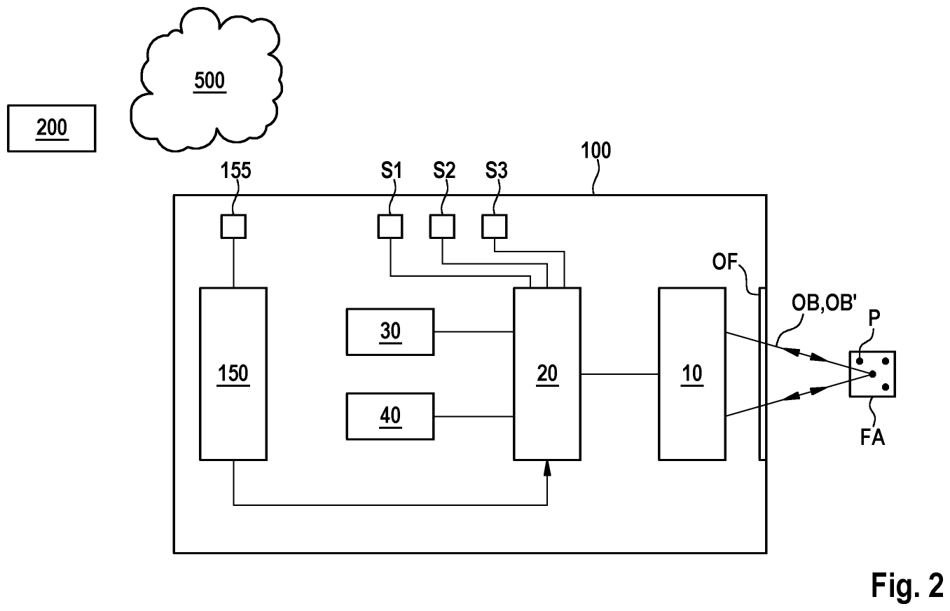

FIG. 2 is a block diagram explaining a portable air quality sensing device according to a second embodiment of the present invention.

The air quality sensing device according to a second embodiment corresponds in essential components to the first embodiment described above.

In the second embodiment, the air quality sensing device additionally comprises first, second and third gas sensing means S1, S2, S3 configured to sense local readings of an instantaneous site-specific gas concentration of predetermined gases.

In particular, the first gas sensor device S1 serves to detect local readings of the CO gas concentration P₂^{local} the second gas sensor device S2 serves to detect local readings of the NOₓ gas concentration P₃^{local} and the third gas sensor device S3 serves to detect local readings of the SOₓ gas concentration P₄^{local} The corresponding readings are transmitted to the evaluation device 20 time-controlled and/or event-controlled.

The functionalities of the retrieval means 150 and the evaluation device 20 for the second version are also different from those of the first version. As an option, these functions can be selected by the user.

The global reading P₅^{global} retrieved by the retrieval means 150 in the second version is the global reading of the air humidity which cannot be measured locally by the air quality sensing device.

The evaluation device 20 is configured to form a corrected local reading of the PM2.5 fine dust particle concentration, which is referred to here as P₁^{local, corrected}. Such a correction compensates the measurement error, which correlates with the humidity.

By means of a correction function fct1 stored in the air quality sensing device, the evaluation device 20 calculates the corrected local reading of the PM2.5 fine dust particle concentration as being

P₁^{local,corrected}=fct1(P₁^{local},P₅^{global})

and calculates the local AQI value to AQI^{local} as being

AQI^{local}=fct(P₁^{local,corrected},P₂^{local},P₃^{local},P₄^{local})

Although the embodiments described detect local readings of certain environmental parameters affecting air quality, the invention is not limited to these parameters, but can be applied to any environmental parameter.

It is also possible that the retrieval means only retrieves a global AQI value and transforms it into a local AQI value using local measurements of certain environmental parameters affecting air quality.

1. A portable air quality sensing device comprising:
an environmental parameter detecting means configured to detect local readings of one or more environmental parameters affecting air quality;
retrieval means for retrieving at least one of a global AQI value and a global reading of an air quality influencing environmental parameter contributing to said global AQI value from at least one remote reading data source means via a network; and
an evaluation device configured to form a local AQI value based on the one or more detected local readings and the at least one retrieved global AQI value and/or on the at least one retrieved global reading.

2. The portable air quality sensing device according to claim 1, wherein the environmental parameter detecting means comprises an optical particle concentration detection device configured to detect local readings of an instantaneous site-specific particle concentration of predetermined particles as the environmental parameter.

3. The portable air quality sensing device according to claim 2, wherein the particle concentration is at least one of a PM2.5 fine dust concentration and a PM10 fine dust concentration.

4. The portable air quality sensing device according to claim 1, wherein said environmental parameter detecting means comprising at least one gas sensor device is configured to detect local readings of an instantaneous site-specific gas concentration of a predetermined gas as said environmental parameter.

5. The portable air quality sensing device according to claim 4, wherein the predetermined gas is one or more of SOₓ, NOₓ, O₃, CO, NH₃, CO₂ and CH₂O.

6. The portable air quality sensing device according to claim 1, wherein said environmental parameter detecting means is configured to detect local readings of a local temperature or a local humidity as said environmental parameter.

7. The portable air quality sensing device according to claim 1, wherein the evaluation device is configured to correct at least one detected local reading of the at least one air quality influencing environmental parameter by means of at least one retrieved global reading for forming the local AQI value.

8. The portable air quality sensing device according to claim 7, wherein the environmental parameter detecting means comprises an optical particle concentration detection device configured to detect local readings of an instantaneous site-specific particle concentration of predetermined particles as the environmental parameter, and wherein the evaluation device is configured to correct a detected local reading of the instantaneous site-specific particle concentration of predetermined particles by means of at least one retrieved global reading.

9. The portable air quality sensing device according to claim 8, wherein the at least one retrieved global reading is an air humidity or a temperature reading or a gas concentration reading.

10. The portable air quality sensing device according to claim 2, wherein the particle concentration sensing means has an optical emitter device for directing at least one optical measuring beam through an optical exit region outside a housing into a focus region within which particle detection can be carried out, and an optical detector device disposed within the housing for detecting the measuring beam scattered by particles and for outputting information about the particle concentration.

11. The portable air quality sensing device according to claim 10, the optical emitter device having a laser diode, in particular a VCSEL diode, and the optical detector device having a photodiode integrated in the laser diode.

12. The portable air quality sensing device according to claim 10, wherein the measuring beam and the scattered measuring beam can be analyzed by the algorithm by means of the self-mixing interference method.

13. The portable air quality sensing device according to claim 1, which is disposed within a smartphone or portable tablet device.

14. The portable air quality sensing device according to claim 1, comprising transmission means for transmitting the formed local AQI value to said at least one reading data source device via said network.

15. An air quality sensing method comprising the steps of:
acquiring local measurements of one or more environmental parameters affecting air quality;
interrogating at least one global AQI value and/or at least one global reading of an air quality influencing environmental parameter contributing to the global AQI value from at least one remote reading data source device over a network; and
forming at least one local AQI value based on the one or more acquired local readings and the at least one retrieved global AQI value and/or on the at least one retrieved global reading.
